(19) United States
(12) Patent Application Publication
(10) Pub. No.: US 2024/0181432 A1
(43) Pub. Date: Jun. 6, 2024

(54) Improved Process for the Manufacture of a Composite Porous Material

(71) Applicant: Hot Lime Labs Limited, Gracefield, Lower Hutt (NZ)

(72) Inventors: Mohammad Nusheh, Karori, Wellington (NZ); Santiago Rosas Florez, Te Aro, Wellington (NZ)

(21) Appl. No.: 18/556,337

(22) PCT Filed: Apr. 19, 2022
(86) PCT No.: PCT/NZ2022/050043

§ 371 Date: Oct. 19, 2023

(30) Foreign Application Priority Data
Apr. 19, 2021 (NZ) 775151

(51) Int. Cl. B01J 20/30; B01D 53/02; B01J 20/02; B01J 20/04; B01J 20/06; B01J 20/28

(52) U.S. Cl. CPC B01J 20/3078; B01D 53/02; B01J 20/0237; B01J 20/0277; B01J 20/041; B01J 20/043; B01J 20/06; B01J 20/28011; B01J 20/2803; B01J 20/3028; B01J 20/3042; B01J 20/305; B01D 2257/504; B01J 2220/46; B01J 2220/56

(57) ABSTRACT

The invention relates to a process for the manufacture of a porous composite material for use in a gas/solid reaction system. The process includes combining at least one active ingredient, organic binder and an inorganic binder to form a mixture, adding water to form green pellets, partially drying and curing the pellets to form a composite material formed from cured pellets having a crushing strength of 4000 g/pellet-20000 g/pellet, suitable for use in a gas/solid reaction system.

### FIELD OF INVENTION

The invention described herein relates to an improved process for the manufacture of a porous, composite material for use in a carbon dioxide capture and storage system.

### BACKGROUND TO THE INVENTION

Methods for the capture and release or storage of carbon dioxide (CO₂) have been around for a number of decades using various methodologies. Typically, the methods currently utilised and in development are focused on removing CO₂ from natural gas (sweetening) and from power plant exhaust gases which require the recovery of pure CO₂ for sequestration at very large scales (^{˜}450 ton/day).

The majority of current approaches use a material (amines, enzymes, mineral carbonates) that reversibly binds CO₂ to achieve the separation. The material is cyclically contacted with the target gas to capture CO₂ and then moved to another vessel where the release of CO₂ is triggered.

Carbon dioxide capture, storage and release processes such as those outlined in PCT/NZ2018/050026 use a sorbent material inside a fixed-bed reactor system through which carbon dioxide is cycled. The sorbent material undergoes numerous cycles at fluctuated high temperatures, under heavy loads of bedding material. Therefore, the strength of the sorbent material must be high enough that it can withstand the weight of the material bed, as well as the effects of thermal shock throughout the cycling system.

The sorbent material must be both reactive and porous enough to facilitate gas-solid reactions and also strong enough to cope with a high load of top layers.

Individual components of a sorbent material, a CO₂ carrier and O₂ carrier, undergo volumetric expansion and contraction during cycling which could collapse the material structure during cycling.

Lime (CaO) reactivity decreases with increasing cycle number, until it reaches a residual CO₂ carrying capacity; and this decline in capacity can be attributed to sintering of CaO particles at high temperatures, resulting in pore shrinkage (a loss of microporosity).

If for any of the above reasons the material falls apart during cycling, the material will convert into fine particles resulting in high pressure drop or clog the fixed bed reactor.

Most of the prior art related to preparation of composite sorbent materials that serve as a CO₂ carrier describes complex and expensive methods for developing the material. These majority of these methods are also not easy to be scaled and are only applicable in lab scale practice.

Pellet making or pelletizing is a well-known method in the ironmaking industry for agglomerating iron ores to be used in shaft furnace processes. However, the majority of patents in this area are focused on using an organic binder to increase the green strength of the pellets, then sintering at high temperatures above 700° C. to sinter pellets for high temperature durability. The sintering process has a negative effect on the carbon dioxide capturing capacity of the sintered material.

### OBJECT OF THE INVENTION

It is an object of the invention to provide a process or method for manufacturing an improved porous composite material for use in carbon capture, storage, and/or release.

Alternatively, it is an object of the invention to provide a process or method for the manufacture of an improved composite porous material for use in gas/solid reactions.

Alternatively, it is an object of the invention to at least provide the public with a useful choice.

### SUMMARY OF THE INVENTION

According to a first embodiment of the invention, there is provided a process for the manufacture of a porous composite material for use in a gas/solid reaction system, the process including;
a) combining at least one active ingredient, organic binder and an inorganic binder to form a mixture A;
b) adding water to mixture A to form green pellets;
c) partially drying the green pellets at 80-180° C. to produce partially dried pellets; and
d) curing the partially dried pellets at 15-50° C. to produce a porous composite material formed from cured pellets.

Preferably, the active ingredients are selected from a carbon dioxide carrying compound, an oxygen carrying compound, a thermochemical storage material or materials for metal air batteries.

In preferred embodiments, the process includes the use of two active ingredients.

Preferably the first active ingredient is a carbon dioxide carrying compound.

In further preferred embodiments, the second active ingredient is an oxygen carrying compound.

In some embodiments, the process includes the further step of heating the cured pellets to remove the organic binder.

In some embodiments, organic binder of step a) may be added as a solid powder or dissolved in water as a liquid binder to form mixture A.

Preferably, the process of adding water at step b) includes spraying the water onto mixture A in an agglomeration machine to form green pellets having a diameter of 0.5 mm-15 mm.

Preferably, the amount of water added is 5-10% w/w of the weight of mixture A.

Preferably, the green pellets have a drop strength of more than 10.

Preferably, the green pellets have a crushing strength of greater than 100 g/pellet, preferably the crushing strength is 100 g-1000 g/pellet, more preferably 400-1000 g/pellet.

More preferably, the step of partially drying the pellets includes drying the pellets for 5 mins-3 hours at 80-150° C.

In other preferred embodiments, the step of partially drying the pellets includes partially drying the pellets until 20-90% of the moisture is removed. More preferably, until 30-50% of the moisture is removed.

Preferably, the step of curing the dried pellets includes storing the pellets at 15-40° C. until the moisture content is less than 1%.

Preferably the curing step includes storing the pellets at 15-40° C. for 1-20 days.

Preferably, the cured pellets have a crushing strength of 4000-20000 g/pellet. More preferably, the crushing strength is between 8000-16000 g/pellet.

Preferably, the step of heating the cured pellets includes heating the pellets to between 300° C.-600° C. More preferably, the heating step is 30-120 minutes, or until the organic binder has been removed from the pellets.

Preferably, the carbon dioxide carrying compound is selected from an alkali metal compound, alkaline earth metal compound. More preferably the carbon dioxide sorbent is limestone, calcium carbonate, calcium oxide, calcium hydroxide or dolomite.

Preferably, the carbon dioxide carrying compound is 50-75% wt. of mixture A.

Preferably the oxygen carrying compound is a transition metal compound. More preferably, the oxygen carrying compound is selected from iron ore, iron oxides, hematite, magnetite, titanomagnetite, copper oxide, copper carbonate or malachite.

Preferably, the oxygen carrying compound is 15%-40% wt. of mixture A.

More preferably, the carbon dioxide carrying compound is calcium carbonate (limestone) or source thereof and the oxygen carrying compound is an iron oxide.

Preferably, the organic binder is selected from one or more of the following groups; polyvinyl alcohols, starches, dextrin, cellulose polymers, polyethylene glycols, lignosulfonates, bitumen, paraffins, wax emulsions, carboxymethyl cellulose, sodium carboxymethyl cellulose or polyacrilates.

Preferably, the organic binder of step a) is 0.01-20% wt. of mixture A. More preferably the organic binder is selected from 3-5% w/w lignosulphonate, 0.01-1% w/w carboxymethyl cellulose or at 5-15% w/w PVA solution.

Preferably, the inorganic binder is selected from one or more of the following groups: alumina silicate, Portland cement, calcium aluminate cements, high alumina cement, calcium hydroxide, sodium silicate, bentonite or clays.

Preferably, the inorganic binder of step a) is 5-15% w/w of mixture A.

According to a further embodiment of the invention, there is provided a process for the manufacture of a porous composite material for use in a gas/solid reaction system, the process including;
a) combining an iron oxide, limestone, an organic binder and an alumina cement to form a mixture A;
b) adding 5-10% w/w water to mixture A in an agglomeration machine to form green pellets;
c) partially drying the green pellets at 100° C. for 30 min-1 hour to produce partially dried pellets; and
d) curing the partially dried pellets for 24 hours at ambient temperature to produce a porous composite material formed from cured pellets.

In some embodiments, the process includes the further step of heating the cured pellets at 500° C. for 1 hour.

According to a further embodiment of the invention there is provided a composite porous material for use in a gas/solid reaction system, the composite porous material produced using any one of the processes described above.

Preferably, the composite porous material produced using the process has a porosity of at least 20%.

Preferably, the green pellets have a drop strength of more than 10 drops.

Preferably, the green pellets have and a crushing strength of greater than 100 g/pellet.

Preferably, the cured pellets have a crushing strength of 4000-20000 g/pellet. More preferably, the crushing strength is between 8000-16000 g/pellet.

For the purposes of this specification an “agglomeration machine” should be taken to refer to any device used for the consolidation of fine solid particles into larger shapes, for example, but not limited to a disc or pan pelletizer, drum pelletizer, cone or mixer pelletizer.

The term “partially dry” with reference to the pellets should be taken to mean the pellets have greater than 1% w/w moisture present. Pellets that are “cured” have less than 1% w/w moisture.

Further aspects of the invention, which should be considered in all its novel aspects, will become apparent to those skilled in the art upon reading of the following description which provides at least one example of a practical application of the invention.

### DESCRIPTION OF THE DRAWINGS

One or more embodiments of the invention will be described below by way of example only, and without intending to be limiting, with reference to the following drawings, in which:

FIG. 1 shows an overview of the known reaction system for carbon dioxide capture and release (PCT/NZ2018/050026) that can utilise the composite porous material of the present invention;

FIG. 2 shows one embodiment of a method of the present invention for forming a composite porous material;

FIG. 3 shows a growth part of pellets within a disc pelletizer in one embodiment of the invention;

FIG. 4 shows the cold bonding mechanism that occurs during the formation of the composite porous material;

FIG. 5 shows the crushing strength (g) of quick-dried samples over a 30-day period; and

FIG. 6 shows the crushing strength (g) of long-dried samples over a 30-day period.

### DETAILED DESCRIPTION OF PREFERRED EMBODIMENTS OF THE INVENTION

Access to clean, cheap and renewable CO₂ is a significant issue in the horticulture industry. The combustion of biomass fuels, especially low grade, has the potential to provide large amounts of CO₂ at low cost. However, CO₂ must be separated from the flue gas as the latter contains a number of undesirable compounds which can be harmful to plants, for example tars, particles, hydrocarbons (ethylene), mono-nitrogen oxides (NOx), sulphur oxides (SOx) and hydrogen chlorine (HCl).

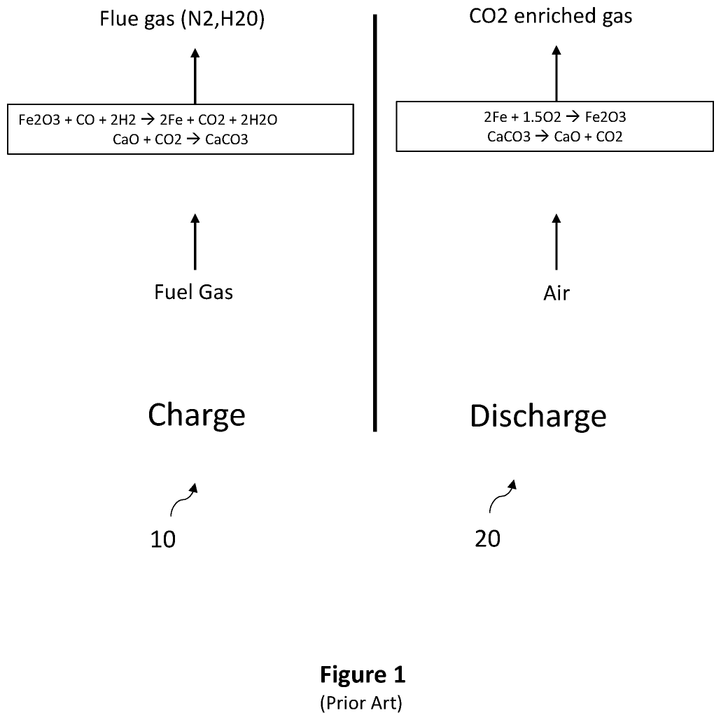

Methods have been developed that focus on the cyclical carburization/oxidation of a transition metal and carbonation/calcination of an alkaline earth metal through a series of auto-thermal reaction steps, as shown in FIG. 1 and discussed in detail in PCT/NZ2018/050026.

The charge regime 10 (FIG. 1) involves flowing a fuel gas through the material bed, resulting in the exothermic carbonation of CaO to CaCO₃, which drives the endothermic reduction of metal oxide to metallic form by reductants in fuel gas, i.e. CO and H₂, forming CO₂ and H₂O.

During the discharge regime 20 air is passed through the material bed, resulting in the exothermic oxidation of metal-to-metal oxide, which drives the endothermic calcination of CaCO₃, releasing CO₂ and reforming the CaO-based CO₂ carrier.

In this process, a composite porous material that includes both a carbon dioxide carrier compound and an oxygen carrying compound is used to achieve the required reactions, typically within a fixed bed reactor.

The composite porous material is adapted to store and release carbon dioxide depending on the phase of the reaction being implemented. In use, a reactor vessel is filled with the composite porous material, with gases moving freely around the material in order to facilitate the reactions.

The operating conditions of the reactor unit, including temperature, total flow rate (residence time), CO₂%, H₂%, and steam % will affect the reactivity of the sorbent to absorb and release CO₂ efficiently. The process for forming the composite porous material of the present invention material has been developed to facilitate and control the kinetics of gas-solid reactions involved in CO₂ cycling and to also address the issues associated with using a standard known pelletization process.

While the process described is for creating a porous composite material for use in a CO₂/O₂ capture and storage system, the process may be used with other active ingredients to create porous materials for other gas/solid reaction systems, including thermochemical storage systems, or metal-air battery systems.

In order to achieve the required strength and reactivity of the composite porous material, a process has been developed that avoids sintering at high temperatures and that can be easily scaled up.

In the current process, organic and inorganic binders that react with additional components are used to confer strength to the composite material at low temperatures.

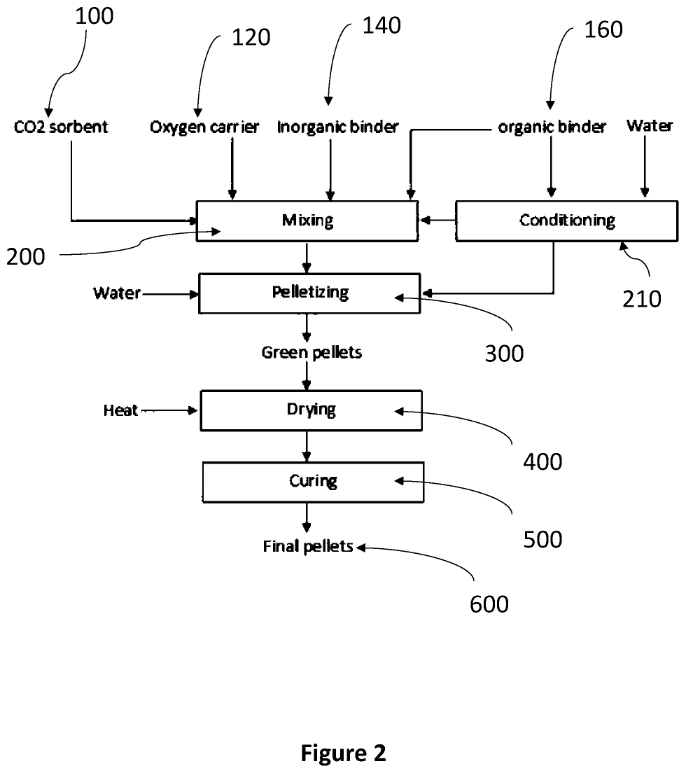

The process for making the composite porous material is outlined in FIG. 2 and combines a carbon dioxide carrier, oxygen carrier, inorganic and organic binders with water.

In the process described, the carbon dioxide carrier is a compound that will bind CO₂ and is preferably selected from an alkali metal compound, alkaline earth metal compound. More preferably the carbon dioxide sorbent is limestone, calcium carbonate, calcium oxide, calcium hydroxide, lithium carbonate or dolomite.

Similarly, the oxygen carrying compound will bind to oxygen and be a transition metal or transition metal containing compound. More preferably, the oxygen carrying compound is selected from iron ore, iron oxides, iron-sand, hematite, magnetite, titanomagnetite, copper oxide, copper carbonate or malachite.

The organic binder is preferably selected from one or more of the following groups; polyvinyl alcohols, starches, dextrin, cellulose polymers, polyethylene glycols, lignosulfonates, bitumen, paraffins, wax emulsions, carboxymethyl cellulose or polyacrilates, with the optimum level of organic binder being 0.01, 0.05, 0.1, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19 or 20% w/w, and more preferably 0.01-5% w/w of mixture A.

The inorganic binder is selected from one or more of the following groups: alumina silicate, Portland cement, calcium aluminate cements, high alumina cement, calcium hydroxide, sodium silicate, bentonite or clays, with an optimum level of inorganic binder being 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29 or 30% w/w of mixture A, more preferably 5-10% w/w of mixture A.

A combination of an inorganic binder such as calcium aluminate cement, along with an organic binder such as lignosulphonate or CMC have been found to be particularly effective in creating composite porous pellets and aiding the retention of CO₂ binding effectiveness over multiple cycles.

A carbon dioxide carrier 100, oxygen carrier 120 and inorganic binder 140 are mixed in a mixer (to form mixture A) with organic binder 160 added either directly as solid powder or dissolved in water as liquid binder (conditioning step 210) and added during the mixing step 200 (or combinations thereof). Typically, although not exclusively, if the organic binder is added as solid powder, only water will be added during the pelletizing step.

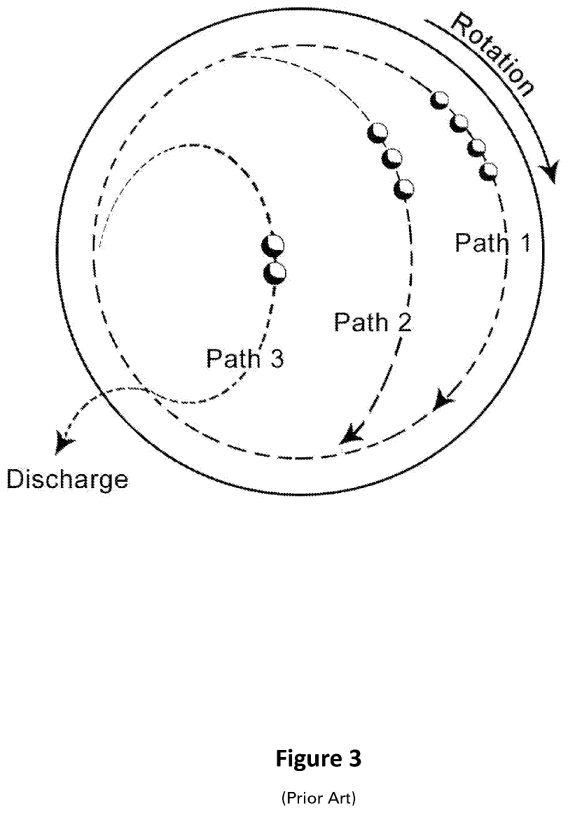

Following mixing, pelletization 300 occurs in an agglomeration machine such as a disc pelletizer, pan pelletizer, drum pelletizer, cone or mixer pelletizer by the addition of water to mixture A. The process occurring within the pelletizer can be seen more clearly in FIG. 3 (prior art) where the standard different growth paths of pellet formation is shown.

The pelletizing happens in two phases, first so-called seeds are formed (path 1) from which larger pellets grow (paths 2 and 3). The nucleation and growing of the pellets are obtained by controlled water spraying on the mixed material A in a pelletizer.

The optimal water content for the formation of green pellets is 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19 or 20%, more preferably between 5-10% w/w of mixed material A.

The amount of organic binder present is a critical factor in pellet formation. Too little or too much organic binder means that insufficient cohesion forces can be developed or muddy balls instead of pellets are formed.

The organic binder promotes green pellet formation, allowing the green pellets to be formed and shaped quickly at ambient or relatively low temperatures, and providing a cold bonding of the green pellets that provides enough strength so the pellets retain their shape and to avoid pellet degradation, before acquiring full strength during the drying and curing process. The time required for pellet formation differs depending on the scale of the pelletization process, but for example, may take 10-30 minutes for a small scale lab-based pelletization process, up to a number of hours for a larger commercial process.

Following the pelletization process, the crushing strength of the green pellets prior to drying is preferably greater than 100 g/pellet and preferably is in the range of 100-1000 g/pellet, and more preferably 150, 200, 250, 300, 350, 400, 450, 500, 550, 600 or 650, 700, 750, 800, 850, 900, 950 or 1000 g/pellet.

Following pelletization, fully formed green pellets have a preferred diameter of 0.5 mm-25 mm, more preferably 0.5-2 mm, 0.5-5 mm, 0.5-10 mm or 0.5-15 mm.

Pellets leave the agglomeration machine and undergo partial drying 400. The partial drying step removes excess water which strengthens the organic binder within the pellet. Partially drying the pellets is preferably undertaken at 80-180° C., with the actual amount of time needed for drying determined by the selection of ingredients within the pellets. More preferably, the step includes partially drying the pellets for 5 mins, 15, 30, 60, 90, 120, 150 or 180 mins at 80-150° C.

Following partial drying, pellets are cured 500 to promote/activate cold bonding with the inorganic binder, further increasing the pellet strength. Curing is preferably undertaken at ambient temperature but may occur at warmer temperatures up to 50 degrees C. depending on the specific conditions such as relative humidity and pellet size and composition, and the curing time available. A typical curing time for dried pellets will be 1, 2, 3, 4, 5, 6 or 7 days at room temperature.

The cured pellets formed using the current process preferably have a crushing strength of 4000-20000 g/pellet. More preferably, the crushing strength is between 8000-16000 g/pellet or may be 4000, 5000, 6000, 7000, 8000, 9000, 10000, 11000, 12000, 13000, 14000, 15000, 16000, 17000, 18000 or 19000 g/pellet or amounts in between.

Heating 600 can follow the curing step in the formation process. This step is optional and can be included in the process if debinding is required. During heating, cured pellets are heated for a short period of time, from 1-2 hours for a laboratory scale operation to several days for a commercial scale operation, burning off the organic binder and leaving a more porous pellet for using the reaction vessel described earlier. Heating temperatures are kept between 400-600° C. in order to retain maximum reactivity, while ensuring the correct strength and porosity required for CO₂ and O₂ cycling.

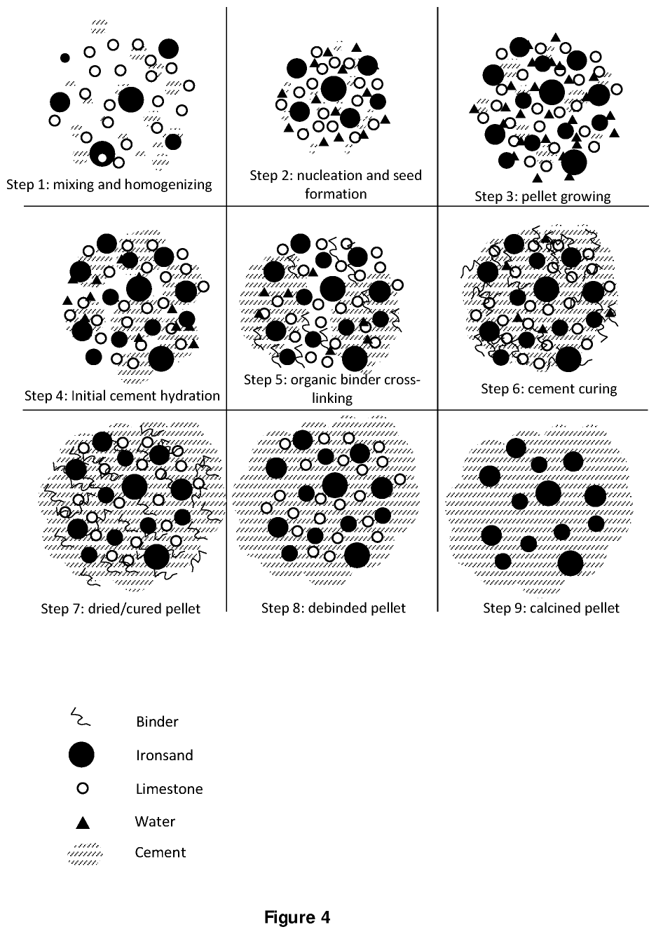

FIG. 4 shows a simplified representation of the formation of pellets of composite porous material from mixing through to the final dried, cured pellets at step 7. Step 8 is optional as described above and step 9 shows a representation of the pellet following use in the reactor. These steps broadly represent the process changes within the pellets as the move through the formation process, but should not be taken to strictly align with the individual process steps. The organic binder is indicated as a squiggle once the binding process begins (rather than on addition to the mixture), and the oxygen carrier, CO₂ carrier and inorganic binder are represented by iron-sand, limestone and cement respectively.

Steps 1 to 3 depict how, following the addition of water within a pelletizer or similar, interfacial forces and capillary pressure form liquid bridges between particles to form seeds and grow to larger pellets. In the example provided by FIG. 4, iron-sand, limestone and cement are mixed at step one to form a homogenous mix. Addition of water at step 2 initiates nucleation and seed formation, and pellets begin to grow by step 3.

Steps 4 to 5 are showing the strengthening of green pellets by a combination of organic binder cross-linking and cement cold-bonding.

As the pellets are dried and cured, porosity increases as shown in steps 6 and 7, with the curing process finished when substantially all the water is consumed by cementitious components. A more porous pellet is achieved as shown at step 8 by removing the binder by initiating an additional heating step.

Last step of binding shown in FIG. 3 is when pellets undergo calcination at high temperatures (>800 C) during cycling which results in binary and ternary phase formation, such as calcium ferrites, due to the solid-state reaction between lime and iron oxide components.

### EXAMPLES

The below examples describe the formation of a pelletized composite porous material at low temperatures in one embodiment of the invention. A number of samples were prepared using different organic binders to test the effect on pellet characteristics such as green strength, cold crushing strength and drop strength, as well as looking at the effects of different drying time on these properties.

Pellet strength is obtained through the use of binders acting as agglomerating agents to provide rapid green strength for facilitating the pelletizing process. Calcium aluminate cement as the inorganic binder provides long term durability at high temperatures.

### Example Materials

SHL0

| Raw Materials | Type | wt % |
|---|---|---|
| CO2 carrier | Limestone | 50.00% |
| O2 carrier | NZ Ironsand | 40.00% |
| Inorganic binder | Calcium aluminate cement | 10.00% |
| Total | — | 100.00% |

50 ml binder (3 wt % lignosulphonate solution) sprayed during pelletizing step.

SHL12

| Raw Materials | Type | wt % |
|---|---|---|
| CO2 carrier | Limestone | 47.00% |
| O2 carrier | NZ Ironsand | 40.00% |
| Inorganic binder | Calcium aluminate cement | 10.00% |
| Organic binder | Lignosulphonate | 3.00% |
| Total | — | 100.00% |

Organic binder dry-mixed

SHL15

| Raw Materials | Type | wt % |
|---|---|---|
| CO2 carrier | Limestone | 49.88% |
| O2 carrier | NZ Ironsand | 40.00% |
| Inorganic binder | Calcium aluminate cement | 10.00% |
| Organic binder | Carboxymethyl cellulose (CMC) | 0.12% |
| Total | — | 100.00% |

Binder dry-mixed

SHL18

| Raw Materials | Type | wt % |
|---|---|---|
| CO2 carrier | Limestone | 49.70% |
| O2 carrier | NZ ironsand | 40.00% |
| Inorganic binder | Calcium aluminate cement | 10.00% |
| Organic binder | anionic polyacrylamide | 0.30% |
| Total | — | 100.00% |

Binder dry-mixed

SHL21

| Raw Materials | Type | wt % |
|---|---|---|
| CO2 carrier | Limestone | 50.00% |
| O2 carrier | NZ ironsand | 40.00% |
| Inorganic binder | Calcium aluminate cement | 10.00% |
| Organic binder | PVA | — |
| Total | — | 100.00% |

160 ml binder (10 wt % PVA solution) sprayed during pelletizing step.

### Methodology

Limestone, iron sand and cement dry powders were mixed and homogenized in a paddle mixer.

In examples SHL12, SHL15 and SHL18, dry binder was included in the initial dry-mixture, while in examples SHL0 and SHL21, the organic binder was mixed in solution with water and sprayed into a laboratory scaled disc pelletizer as per conditioning step 210.

After formation, green pellets were separated into three different pellet sizes ranging from <5 mm as undersized, 5-15 mm as final product and >15 mm as oversized.

Immediately following manufacture, green pellet drop number and crushing strength were measured. Then, the pellets underwent a quick and a long partial drying process and their strength was measured again. The quick drying process consisted of introducing the pellets in a furnace at 150° C. for 8 min while in the long drying process the pellets remained in the furnace for 60 min at the same temperature. Their crushing strength was measured over time up to 33 days of being made.

Crushing strength is determined using a standard process ISO4700.

A drop test was also performed on the pellets to determine the average number of drops a pellet survives when repeatedly dropped from a height of 45 cm on to a steel plate. A minimum of 10 drops are used to calculate the average.

### Results

Following pellet formation, pellets were tested for green crushing strength and average values recorded.

Crushing strength was again recorded following the quick drying process and again following the long drying process, with average values across pellets recorded below.

| | SHL0 | SHL12 | SHL15 | SHL18 | SHL21 |
|---|---|---|---|---|---|
| Ease of pelletizing | Very good | Very good | Good | Good | Good |
| Pelletizing yield (6.75- | 48.90% | 35.70% | 30.80% | 23.50% | 16.60% |
| 9.5 mm) | | | | | |
| Water/ cement ratio | 0.7 | 0.73 | 1.5 | 1.4 | 0.96 |
| Green crushing | 220 | 454 | 376 | 150 | 123 |
| strength (g) | | | | | |
| Avg Quick Dry Crushing | 225 | 4847 | 923 | 1030 | 3013 |
| Strength (g) | | | | | |
| 8 mins @ 150° C. | | | | | |
| Avg Long Dry Crushing | 225 | 12367 | 5853 | 4167 | 8456 |
| Strength (g) | | | | | |
| 1 hr @ 150° C. | | | | | |
| Debinded crushing | — | — | 7100 | — | 5088 |
| strength (g) | | | | | |
| Drop Test (number of | 4 | 13 | 10 | 8 | 11 |
| drops) | | | | | |

Crush strength over an extended period of time was also recorded for the three most successful samples, SHL12, SHL15 and SHL21, which use lignosulfonate, CMC and PVA respectively as the organic binders.

Sample SHL15 was expanded to include five further samples, each with a different concentration of CMC binder; 0.06%, 0.12%, 0.20%, 0.30% and 0.50%.

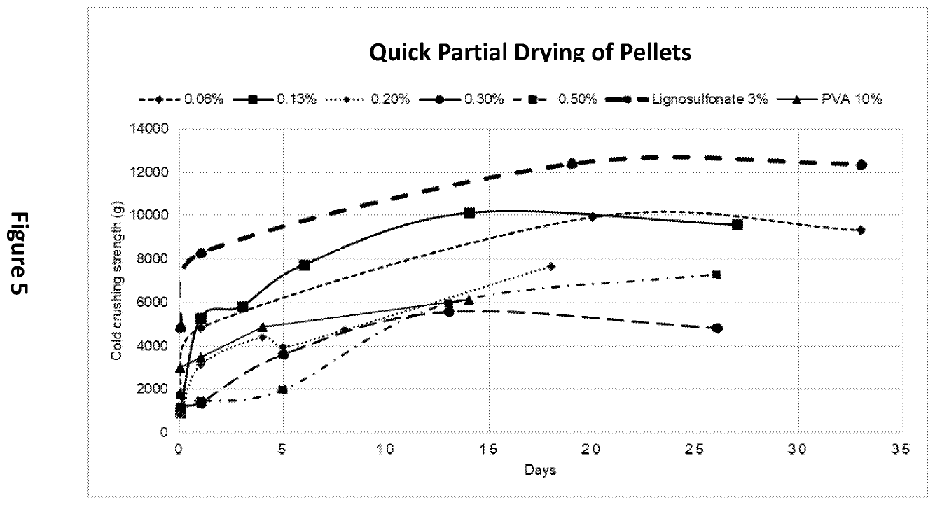

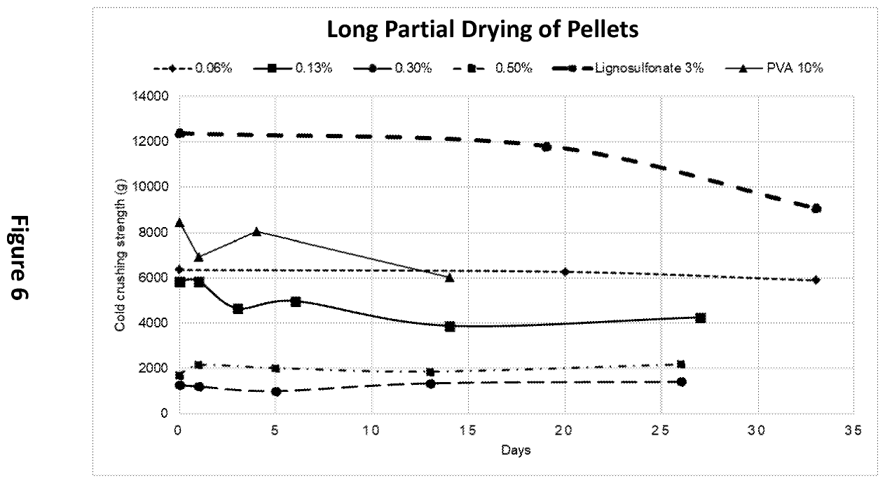

FIGS. 5-6 show the crushing strength of pellets of each formulation of a 30-day curing period following manufacture.

FIG. 5 shows the change in pellet strength when adding a quick-drying step following green pellet formation of 8 minutes at 150° C., and FIG. 6 when using the long-drying process of 1 hour at 150° C. In both FIGS. 5 and 6, day zero as shown on the graphs is equivalent to the time immediately following the conclusion of the quick and long drying periods respectively.

### Result Analysis

Experiments using different types of binders yielded diverse results in terms of crushing strength after undergoing heat treatment. Lignosulfonate and PVA pellets developed the highest strength immediately following a long dry period of 1 hr at 150° C.

Comparing SHL0 and SHL12, where the lignosulfonate binder was sprayed in solution and dry mixed respectively, SHL12 outperformed the sprayed binder significantly when comparing both green pellet strength and crushing strength after both quick and long drying.

As with other sample SHL15 showed significant improvements in strength with an extended drying time, indicating that extended drying time generally results in increased crushing strength

Anionic polyacrylamide binder sample SHL18 produced pellets with a greater initial green strength than PVA but was outperformed by PVA following long drying.

The changes in binder composition as shown in FIGS. 5 and 6 demonstrate the amount of binder in the composition influences pellet crushing strength over time.

FIG. 5 shows the crushing strength of quick dried pellets (8 minutes, 150° C.). Immediately after drying, lignosulfonate and PVA pellets improved their strength considerably and strength increased as the days passed. The quick drying process increased slightly the CMC pellets initial strength and it grew over time.

At low binder concentrations (0.06%-0.2%), the not-dried pellets acquired comparable or better strength than both the quick-dried and long-dried pellets after both 5 days and 30 days.

For higher binder concentrations (0.3-0.5%), the quick-dried pellets produced the best 5 day and 30-day strength results. For example, non-dried 0.5% CMC pellets displayed a crushing strength of approx. 2 kg after 25 days, compared to 7 kg for the quick-dried 0.5% CMC samples.

FIG. 6 depicts the crushing strength of long dried pellets (1 hr, 150° C.). Lignosulfonate showed the best results followed by PVA pellets. Again, smaller concentrations of CMC binder had higher strength results compared to pellets with higher binder concentrations, although maximum binding strength was achieved for most samples directly after the long-drying period, with no further, or minimal strength gains over time.

Lignosulfonate binder produced the best in the three scenarios. In addition, PVA pellets performed better after a long-drying process while CMC pellets grew very strong over time only when water was still present within the material.

Pellets harden during the curing process as the cementitious minerals in the cement hydrate or react with water. Cement hardening occurs due to hydration reactions. As the hydration reactions progress, pellet strength increases. As such, fully drying the pellets during the drying phase is not beneficial for this process as it removes the water required for these reactions. In preferred embodiments, the step of drying the pellets includes drying the pellets until 10, 15, 20, 25, 30, 35, 40, 45, 50, 55, 60, 65, 70, 75, 80, 85 or 90% of the moisture is removed. More preferably, until 30-50% of the moisture is removed.

The strength behaviour of pellets made with CMC may be explained by the effect of CMC on the cement. CMC retards the setting time of the cement as an additive in mortars. CMC can compete with the cement for the water present in the pellets and at high concentrations inhibiting its hardening process. As a result of this, there is an inflection point where CMC binder sequesters the water in the material and completely stops the cement from setting. This correlates with the acquired results as 0.12% of CMC had the best results and higher concentrations did not perform as well, due to the unavailability of water for cementation.

The different water absorbing capabilities of different binders will influence the amount of binder used and the resulting pellet strength.

The dosage of the organic binding agent is a key factor for agglomeration. Too little or too much organic binding agent means that insufficient cohesion forces can be developed or muddy balls instead of pellets are formed. The preferred amount of organic binder is between 0.01-20% w/w, and more preferably 0.01-5% w/w of mixture A, with the preferred amount used depending on the binder type, binder specifications from the manufacturer and the hydrophilicity of the binder.

The process of pellet formation disclosed above is designed to be easily scaled up for large quantity manufacturing while maximising pellet strength.

While the process described above describes the use of two active ingredients, a carbon dioxide carrier and an oxygen carrier, alternative active ingredients may be used in the same or similar pelletization process in situations where the active ingredients cannot be exposed to high temperatures.

For example, when creating thermochemical storage materials active ingredients may be selected from calcium, magnesium, lithium, sodium, aluminium, barium, sulphur, strontium and carbonates, chlorides, nitrates, sulphates, sulphides, bromides and other salts or salt hydrates thereof. Thermochemical storage materials may be combined with a microporous sorbent as host matrix (supporting material). Sorbents may include, but are not limited to zeolites, silica gels, vermiculite, activated carbon, graphite, expanded natural graphite, biochar, cementitious materials like ettringite, Portland cement, calcium aluminate cement.

To create materials for metal-air batteries, active ingredients may include zinc, lithium, iron, magnesium, sodium metals and other salts thereof.

Carbon dioxide and oxygen carriers may be used as active ingredients in a range of solid/gas reactions in combination with other active ingredients. Examples of CO₂ carriers that may be used include, but are not limited to magnesium, calcium, lithium, sodium, and carbonates and oxidisable salts thereof. Examples of O₂ carriers include but are not limited to copper, nickel, iron, manganese, molybdenum, cobalt, and oxides and reducible salts thereof.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A process for the manufacture of a porous composite material for use in a gas/solid reaction system, the process including;
a) combining at least one active ingredient, organic binder and an inorganic binder to form a mixture A;
b) adding water to mixture A to form green pellets;
c) partially drying the green pellets at 80-180° C. to produce partially dried pellets; and
d) curing the partially dried pellets at 15-50° C. to form a porous composite material made from cured pellets;
wherein the cured pellets formed using steps a)-d) have a crushing strength of 4,000-20,000 g/pellet.

2. The process of claim 1 including two active ingredients, wherein the active ingredients are a carbon dioxide carrying compound selected from an alkali metal compound, alkaline earth metal compound; and an oxygen carrying compound in the form of a transition metal compound.

3. The process of claim 2, wherein the carbon dioxide carrying compound is selected from limestone, calcium carbonate, calcium oxide, calcium hydroxide or dolomite; and the transition metal compound is iron ore, iron oxides, hematite, magnetite, titanomagnetite, copper oxide, copper carbonate and/or malachite.

4. The process of claim 2, wherein the carbon dioxide carrying compound is 50-75% wt. of mixture A.

5. The process of claim 2, wherein the oxygen carrying compound is 15%-40% wt. of mixture A.

6. (canceled)

7. The process of claim 1, wherein the organic binder is selected from one or more of the following groups; polyvinyl alcohols, starches, dextrin, cellulose polymers, polyethylene glycols, lignosulfonates, bitumen, paraffins, wax emulsions, carboxymethyl cellulose, sodium carboxymethyl cellulose or polyacrilates.

8. The process of claim 7, wherein the organic binder of step a) is 0.01-20% w/w. of mixture A.

9. The process of claim 8, wherein the organic binder is selected from 3-5% w/w lignosulphonate, 0.01-1% wt carboxymethyl cellulose or at 5-15% w/w PVA solution.

10. The process of claim 1, wherein the inorganic binder is selected from one or more of the following groups: alumina silicate, Portland cement, calcium aluminate cements, high alumina cement, calcium hydroxide, sodium silicate, bentonite or clays.

11. The process of claim 10, wherein the inorganic binder is 5-15% w/w of mixture A.

12. The process of claim 1, wherein adding water at step b) includes spraying the water onto mixture A in an agglomeration machine to form green pellets having a diameter of 0.5 mm-15 mm.

13. The process of claim 12, wherein the amount of water added is 5-10% w/w of the weight of mixture A.

14. The process of claim 1, wherein the green pellets produced at step b) a green drop strength of greater than 10 drops when repeatedly dropped from a height of 45 cm on a steel plate.

15. The process of any ms claim 13, wherein the green pellets produced at step b) have a crushing strength of greater than 100 g/pellet.

16. (canceled)

17. The process of claim 15, wherein the pellets are dried for 5 mins-3 hours.

18. The process of claim 1, wherein the green pellets are partially dried at step c) until 30-50% of the moisture is removed.

19. The process of claim 1, wherein the step of curing the pellets includes storing the pellets at 15-50° C. until the moisture content is less than 1%.

20. (canceled)

21. The process of claim 1, wherein the process includes the further step of heating the cured pellets.

22. The process of claim 21, wherein the step of heating the cured pellets includes heating the pellets to between 300° C.-600° C. for 30-120 minutes, or until the organic binder has been removed the pellets.

23. (canceled)

24. A composite porous material for use in a gas/solid reaction system produced using the process of claim 1, wherein the composite porous material has a porosity of at least 20% and a crushing strength of 4,000-20,000 g/pellet.

25-26. (canceled)
